(19) United States
(12) Patent Application Publication
(10) Pub. No.: US 2023/0251215 A1
(43) Pub. Date: Aug. 10, 2023

(54) X-RAY FLUORESCENCE ANALYZER, DATA PROCESSING METHOD, AND RECORDING MEDIUM

(71) Applicant: Shimadzu Corporation, Kyoto -shi (JP)

(72) Inventor: Yuta SAITO, Kyoto-shi (JP)

(21) Appl. No.: 18/098,352

(22) Filed: Jan. 18, 2023

(30) Foreign Application Priority Data
Feb. 7, 2022 (JP) 2022-017407

(51) Int. Cl. G01N 23/223

(52) U.S. Cl. CPC G01N 23/223; G01N 2223/076; G01N 2223/507

(57) ABSTRACT

A method of processing an initial spectrum of a sample acquired by processing an output of an X-ray detector is provided. A processor calculates a predictive value of a count value forming sum peaks, for each of one or more elements constituting the sample, using a count value and a value of energy of characteristic X-rays in the initial spectrum energy and subtract the predictive value calculated for each of the one or more elements constituting the sample from the count value of the initial spectrum to remove the sum peaks from the initial spectrum.

### CROSS-REFERENCE TO RELATED APPLICATIONS

This application claims priority under 35 U.S.C. § 119 to Japanese Patent Application No. 2022-017407 filed on Feb. 7, 2022, the entire disclosure of which is incorporated herein by reference in its entirety.

### BACKGROUND OF THE INVENTION

### Field of the Invention

The present disclosure relates to an X-ray fluorescence analyzer, a data processing method, and a recording medium.

### Description of Related Art

The following description sets forth the inventor's knowledge of related art and problems therein and should not be construed as an admission of knowledge in the prior art.

In a profile of an analysis result of an X-ray fluorescence analyzer, not only a main peak (e.g., Kα ray) but also sum peaks are present. The intensity of a sum peak depends on a count rate and a time resolution of a detector. A method for deriving a ratio of the intensity I₍ₘ₊₁₎ of the m^{th} sum peak to the intensity I₍₁₎ of the main peak using a count rate and a peaking time is disclosed in the following article (NPL1). Article: Ryohei Tanaka et al., “Artificial peaks in energy dispersive X-ray spectra: sum peaks, escape peaks, and diffraction peaks,” X-RAY SPECTROMETRY, John Wiley & Sons, Ltd., 2017, 46, p. 5-11

### SUMMARY OF THE INVENTION

In a case where sum peaks are removed from a profile of an analysis result by using a conventional method as disclosed in the above-described NPL1, a situation in which sum peaks are removed more than necessary and a situation in which sum peaks are removed insufficiently have occurred.

The present invention was made in view of the above-described circumstances. An object of the present invention is to provide a technique for appropriately removing sum peaks in an analysis result of an X-ray fluorescence analyzer.

An X-ray fluorescence analyzer according to one aspect of the present disclosure is provided with:

an X-ray detector configured to detect X-rays of a sample;

a data processing unit configured to generate an initial spectrum of the sample by processing an output of the X-ray detector; and

a processor configured to perform removal processing for removing one or more sum peaks from the initial spectrum,

wherein the removal processing includes:

calculating a predictive value of a count value forming a sum peak, for each of one or more elements constituting the sample, using a count value and a value of energy of characteristic X-rays in the initial spectrum; and

subtracting the predictive value calculated for each of the one or more elements constituting the sample from the count value of the initial spectrum.

A date processing method according to one aspect of the present disclosure related to a data processing method of processing an initial spectrum of a sample acquired by processing an output of an X-ray detector. The method includes the steps of:

calculating a predictive value of a count value forming a sum peak, for each of one or more elements constituting the sample, using a count value and a value of energy of characteristic X-rays in the initial spectrum; and subtracting the predictive value calculated for each of one or more elements constituting the sample from the count value of the initial spectrum.

A recording medium according to one aspect of the present disclosure is configured to store a program non-temporarily,

wherein the program is executed by a computer to make the computer perform the above-described data processing method.

The above-described objects and other objects, features, aspects, and advantages of the present invention will become apparent from the following detailed descriptions of the present invention that can be understood with reference to the attached drawings.

### BRIEF DESCRIPTION OF THE DRAWINGS

The preferred embodiments of the present invention are shown by way of example, and not limitation, in the accompanying figures.

FIG. 1 is a diagram showing a configuration example of an X-ray analyzer 1 according to this embodiment.

FIG. 2 is a diagram for explaining conversion processing from a differential wave to a trapezoidal wave.

FIG. 3 is a diagram showing one example of a wave height distribution diagram generated by an X-ray analyzer 1 based on a count value stored in a histogram memory 54.

FIG. 4 is a diagram for explaining the calculation of a predictive value about a sum peak using a count value of a main peak.

FIG. 5 is a diagram showing one example of an initial spectrum about Fe.

FIG. 6 is a diagram showing one example of the difference between detected data and a simulation result.

FIG. 7 is a diagram showing one example of a spectrum after removing sum peaks.

FIG. 8 is a flowchart of processing executed by an X-ray analyzer 1 for setting an offset value.

FIG. 9 is a diagram showing one example of a change in the spectrum after removing sum peaks by using an offset value.

FIG. 10 is a diagram showing one example of setting data to be used for data processing, which will be described later with reference to FIG. 11.

FIG. 11 is a flowchart of the processing executed by the X-ray analyzer 1 for outputting a wave height distribution diagram using a sample detection result.

### DESCRIPTION OF THE PREFERRED EMBODIMENT

Hereinafter, some embodiments of the present disclosure will be described in detail with reference to the attached drawings. In the drawings, the same or corresponding component is assigned by the same reference symbol, and the description thereof will not be repeated.

### <Configuration of X-Ray Analyzer 1>

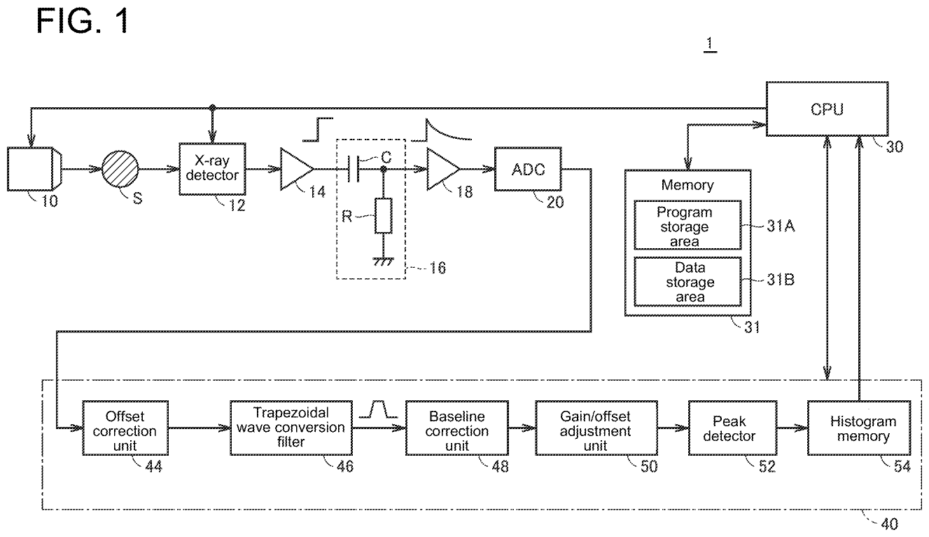

FIG. 1 is a diagram showing a configuration example of an X-ray analyzer 1 according to this embodiment. In one implementation, the X-ray analyzer 1 is an energy dispersion X-ray fluorescence analyzer. As shown in FIG. 1, the X-ray analyzer 1 includes an X-ray tube 10, an X-ray detector 12, a preamplifier 14, a differential circuit 16, an amplifier 18, an ADC (Analog to Digital Converter) 20, a CPU (Central Processing Unit) 30, a memory 31, and a signal processing device 40. The X-ray detector 12 is an energy dispersive spectrometer. The signal processing device 40 is an X-ray analysis signal processing device.

The X-ray tube 10 emits primary X-rays to a sample S. The X-ray tube 10 includes, for example, a target as an anode, a filament as a cathode, and a housing accommodating the target and the filament. When a high voltage is applied to the target, and a low voltage is applied to the filament, thermal electrons radiated from the filament collide against the end face of the target, thereby generating primary X-rays at the end face. The primary X-rays generated at the end face of the target are emitted to the sample S. When the primary X-rays are emitted to the sample S, X-ray fluorescence excited by the primary X-rays is emitted from the sample S and is incident on the X-ray detector 12.

The X-ray detector 12 detects the intensity of the X-ray fluorescence in a predetermined wavelength range. The X-ray detector 12 is arranged in the housing and has a detection element for detecting the intensity of the X-ray fluorescence in the wavelength region. The detection element is, for example, a lithium-drift Si semiconductor device.

The output signal of the X-ray detector 12 is amplified with the preamplifier 14. The output signal becomes a stepped-like wave signal by the preamplifier 14. Each step of the stepped-like wave signal indicates the detection of the X-ray fluorescence. The height of each step represents the wavelength λ, i.e. the X-ray energy E.

The output signal amplified by the preamplifier 14 is sent to a differential circuit 16. The differential circuit 16 is composed of a capacitor C and a resistor R and is configured to convert a step-like wave into a differential wave represented by the following Equation (1). By converting a step-like wave into a differential wave, the dynamic range can be widened. Consequently, a high resolution can be acquired. The differential wave is amplified by the amplifier 18 and sent to an ADC 20.

y=exp(−nT/τ)=a″ (1)

where τ(=RC) is a time constant, T is a sampling period, n is the number of samples, and a is (exp(−T/τ)).

The ADC 20 samples the differential wave, which is an analog signal, at a predetermined sampling period and converts it into a digital signal (hereinafter referred to as “differential wave digital signal”). The differential wave digital signal is inputted to the signal processing device 40.

The signal processing device 40 is generally constituted by a logic device, such as, e.g., an FPGA (Field-Programmable Gate Array).

In this embodiment, the signal processing device 40 includes an offset correction unit 44, a trapezoidal wave conversion filter 46, a baseline correction unit 48, a gain/offset adjustment unit 50, a peak detector 52, and a histogram memory 54.

The offset correction unit 44 performs the offset-correction of the differential wave digital signal given from the ADC 20 and outputs the corrected differential wave digital signal to a trapezoidal wave conversion filter 46.

The trapezoidal wave conversion filter 46 is a digital filter configured to convert the differential wave corrected by the offset correction unit 44 into a trapezoidal wave represented by the following Equation (2).

$$h ( z ) = \frac{1 - {aZ}^{- 1}}{1 - 2 {Z}^{- 1} + {Z}^{- 2}} \{ \frac{1 - {Z}^{- N} - {Z}^{- ( N + M )} + {Z}^{- ( 2 N + M )}}{N} \} \qquad ( 2 )$$

In Equation (2), M corresponds to a top-bottom time of a trapezoidal wave, and N represents a rise time and a fall time of the trapezoidal wave.

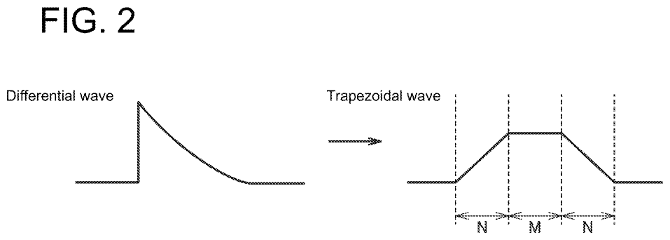

FIG. 2 is a diagram for explaining the conversion processing from a differential wave to a trapezoidal wave. The differential wave shown on the left side of FIG. 2 is converted by the trapezoidal wave conversion filter 46 into a trapezoidal wave in which both the rise time and the fall time are N, and the time of the top-bottom is M, as shown on the right side of FIG. 2.

The output waveform generated by the trapezoidal wave conversion filter 46 is inputted to a peak detector 52 after the baseline and the gain are adjusted by a baseline correction unit 48 and a gain/offset adjustment unit 50.

The peak detector 52 detects the peak of the output waveform and acquires the peak value (peak top value) of each peak. The peak detector 52 increments the count value of the X-ray energy E according to the peak top value for each peak and stores it in the histogram memory 54.

The memory 31 includes a program storage area 31A for storing program data and a data storage area 31B for storing data. The X-ray analyzer 1 performs various processing by the CPU 30 executing programs stored in the program storage area 31A (or a storage unit outside the X-ray analyzer 1). In the program storage area 31A, the program may be stored non-temporarily.

The CPU 30 generates a wave height distribution diagram (energy spectrum histogram) based on the count value stored in the histogram memory 54. The wave height distribution diagram indicates the X-ray fluorescence energy E in the horizontal axis and the content (intensity) of the element in the vertical axis. In the wave height distribution diagram, each element-specific peak appears at the position corresponding to the energy E of the X-ray fluorescence emitted from the element contained in the sample S. The CPU 30 performs a qualitative analysis and a quantitative analysis of the contained elements based on the appearance positions of the peaks, the X-ray intensity values thereof, and the like.

### <Sum Peaks>

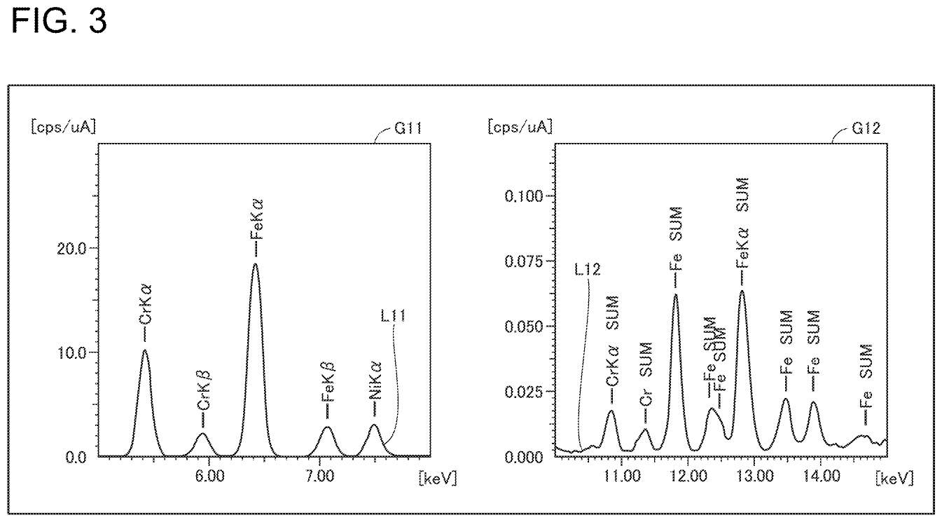

FIG. 3 is a diagram showing one example of a wave height distribution diagram generated by the X-ray analyzer 1 based on the count value stored in the histogram memory 54. The wave height distribution diagram of FIG. 3 is directed to stainless-steel (Ni containing SUS) containing Ni, as a sample S. FIG. 3 shows a wave height distribution diagram G11 on the lower energy side and a wave height distribution diagram G12 on the higher energy side. In the wave height distribution diagram, the horizontal axis represents the energy, and the vertical axis represents the number of counts of X-ray photons. Note that in this specification, unless otherwise specified, the horizontal axis and the vertical axis of a wave height distribution diagram are the same as the horizontal axis and the vertical axis of FIG. 3.

In the wave height distribution diagram G11, so-called main peaks are shown. A main peaks is a peaks due to the characteristic X-rays of each element. The line L11 of the wave height distribution diagram G11 is a spectrum including five peaks. The five peaks correspond to the Kα ray of Cr, the Kβ ray of Cr, the Kα ray of Fe, the Kβ ray of Fe, and the Kα ray of Ni, in ascending order of energy.

In the wave height distribution diagram G12, so-called sum peaks are shown. Sum peaks are a kind of ghost peaks observed in a wave height distribution diagram. When two X-rays are incident on the detector at short intervals, the detector cannot measure the two X-rays separately and may measure them as one X-ray. As a result, two X-rays are observed as a peak having an energy acquired by adding the energies of the two X-rays. The peaks observed in this way are sum peaks.

The line L12 of the wave height distribution diagram G12 is a spectrum including eight peaks apparently. The peak located at the lowest energy position is a sum peak due to the Kα ray of Cr. The peak located at the second lowest energy position is a sum peak due to Cr. The third lowest energy location is a sum peak due to Fe. The peak located at the fourth lowest energy location is a peak in which two sum peaks due to Fe are superimposed. The peak located at the fifth lowest energy position is a sum peak due to the Kα ray of Fe. Each of the three higher energy peaks (the peaks located at the 6th to 8th higher energy positions) is a sum peak due to Fe.

The X-ray analyzer 1 generates a wave height distribution diagram based on the count value stored in the histogram memory 54. In this specification, a wave height distribution diagram generated as described above is also referred to as “initial wave height distribution diagram.” A spectrum included in an initial wave height distribution diagram is one example of an “initial spectrum.”

The X-ray analyzer 1 generates a wave height distribution diagram for outputting by removing sum peaks from an initial spectrum. In this specification, a spectrum included in a wave height distribution diagram generated as described above is also referred to as “final spectrum.”

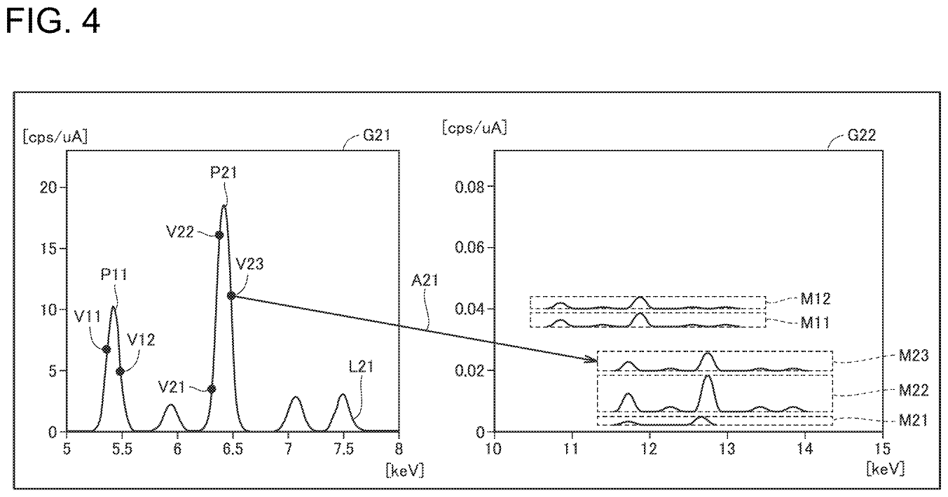

The X-ray analyzer 1 uses a count value of a main peak of an element due to each sum peak to remove a sum peak, as will be described later with reference to FIG. 4, etc.

### <Count Value to be Removed as Sum Peak>

FIG. 4 is a diagram for explaining the calculation of a predictive value about a sum peak, using a count value of a main peak. FIG. 4 includes a wave height distribution diagram G21 and a wave height distribution diagram G22. The wave height distribution diagram G21 corresponds to an energy region of the five main peaks in the initial spectrum acquired for a given sample. The wave height distribution diagram G22 schematically shows a predictive value calculated using the count value of the main peak in the wave height distribution diagram G21. The calculation of the predictive value shown in the wave height distribution diagram G22 will be described in more detail.

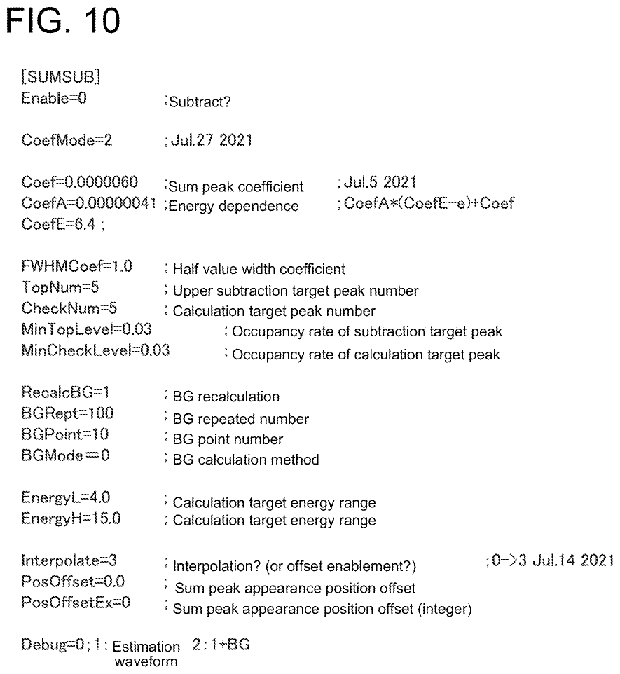

The X-ray analyzer 1 calculates the predictive value of the count value of the sum peak due to the element corresponding to the main peak P11, using the count value in a given energy range around the center position of the main peak P11. The given energy range around the center position of the peak will be described below as a half width FMHMCoef, with reference to FIG. 10.

In FIG. 4, the count value predicted from the main peak P11 is indicated in the frame M11 and the frame M12. In the frame M11, the predictive value calculated from the count value in the vicinity of the point V11 located on the lower energy side of the center position of the main peak P11 is shown. The predictive value in the frame M11 has a value around 10.7 to 13.2 keV. In the frame M12, the predictive value calculated from the count value in the vicinity of the point V12 located on the higher energy side of the center position of the main peak P11 is shown. The predictive value in the frame M12 has a value around 10.7 to 13.2 keV.

The X-ray analyzer 1 calculates the predictive value of the count value of the sum peak due to the element corresponding to the main peak P21, using the count values of a given energy range around the center position of the main peak P21.

In FIG. 4, the predictive values corresponding to the main peak P21 are indicated in the frames M21 to M23. In the frame M21, the predictive value calculated from the count value in the vicinity of the point V21 located on the lower energy side of the center position of the main peak P21 is shown. The predictive value in the frame M21 has a value around 11.5 to 12.9 keV. The frame M22 shows the predictive value calculated from the count value in the vicinity of the point V22 located on the lower energy side of the center position of the main peak P21 and on the higher energy side of the point V22. The predictive value in the frame M22 is a value around 11.5 to 14.1 keV. In the frame M23, the predictive value calculated from the count value in the vicinity of the point V23 located on the higher energy side of the center position of main peak P21 is shown. The predictive value in the frame M23 is a valued around 11.5 to 14.1 keV.

As described with reference to FIG. 4, the X-ray analyzer 1 calculates a predictive value of the count value of the sum peak predicted to be generated due to the element corresponding to the main peak, for each of one or more main peaks. The predictive values calculated for the main peak P11 are shown in the frames M11 and M12. The predictive values calculated for the main peak P21 are shown in the frames M21 to M23.

The X-ray analyzer 1 calculates the above-described predictive values for each of one or more elements contained in the sample. Further, the X-ray analyzer 1 derives the predictive values of all of the sum peaks contained in the initial spectrum by adding the predictive values calculated for each of the one or more elements. The X-ray analyzer 1 generates the final spectrum by subtracting the predictive values of all of the sum peaks from the initial spectrum.

### <Calculation Method of Predictive Value>

The following Equation (3) represents an equation used by the X-ray analyzer 1 to calculate a predictive value for the m^{th} sum peak of an element.

I₍ₘ₊₁₎={(c·r)^{m}/(m+1)!}·I₁·CoefMode (3)

In Equation (3), “I₍ₘ₊₁₎” represents the count value (predictive value) of the m^{th} sum peak. “c” represents the count rate (cps), and “r” represents the peaking time. “c” and “r” are described in the following article. Article: NPL1 (Ryohei Tanaka, Koretaka Yuge, Jun Kawaia, Hussain Alawadhib, Artificial peaks in energy dispersive X-ray spectra: sum peaks, escape peaks, and diffraction peaks, X-RAY SPECTROMETRY, John Wiley & Sons, Ltd., 2017, 46, p5-p11)

“I₁” indicates the count value (detected value) of the main peak.

The CoefMode of Expression (3) is expressed by the following Expression (4).

CoefMode=CoefA×(CoefE−e)+Coef (4)

Each CoefA, CoefE, and Coef is a predetermined constant. “e” represents the energy of the characteristic X-rays of the element as the target of the predictive value calculation.

The CoefE may be the energy of the characteristic X-rays of the reference element in the X-ray analyzer 1. In this case, the term “CoefE-e” in Equation (4) represents the difference in the energy of the characteristic X-rays between the reference element and the calculation target of the predictive value.

For example, an example is assumed in which Fe is used as a reference element. The energy of the characteristic X-rays of Kα of Fe is 6.398 (about 6.40) keV). In this case, the value of CoefE is set to 6.40.

The energy of the characteristic X-rays of Kα of Cu is about 8.04 keV. In the above-described example, when calculating the sum peak due to Cu, since 8.04 (keV) is used as “e,” the CoefMode is derived according to the following Equation (5).

CoefMode=CoefA×(6.40−8.04)+Coef (5)

On the other hand, in the above-described embodiment, when calculating the sum peak due to Fe, since 6.40 (keV) is used as “e,” the CoefMode is derived according to the following Equation (6). That is, the CoefMode is simply derived as the Coef itself.

CoefMode=CoefA×(6.40−6.40)+Coef=Coef (6)

As described with reference to Equation (6), when the energy of the characteristic X-rays of a given element is employed as a CoefE, the calculation can be simplified in calculating the predictive value about the sum peak due to the element.

In calculating the predictive value described with reference to Equations (3) to (6), the CoefA may be a positive value. In this case, when the value of “e” increases, the value of the CoefMode decreases. When the value of the CoefMode decreases, the value of I₍ₘ₊₁₎ calculated according to Equation (3) also decreases. That is, the predictive value of the count value of the sum peak calculated according to Equation (3) has a coefficient (Coef) that decreases as the energy of the characteristic X-rays of the target element increases. With this, in the data processing method for removing sum peaks according to this embodiment, the energy dependence of X-rays at the sum peak rate may be considered.

### <Setting of Offset Value>

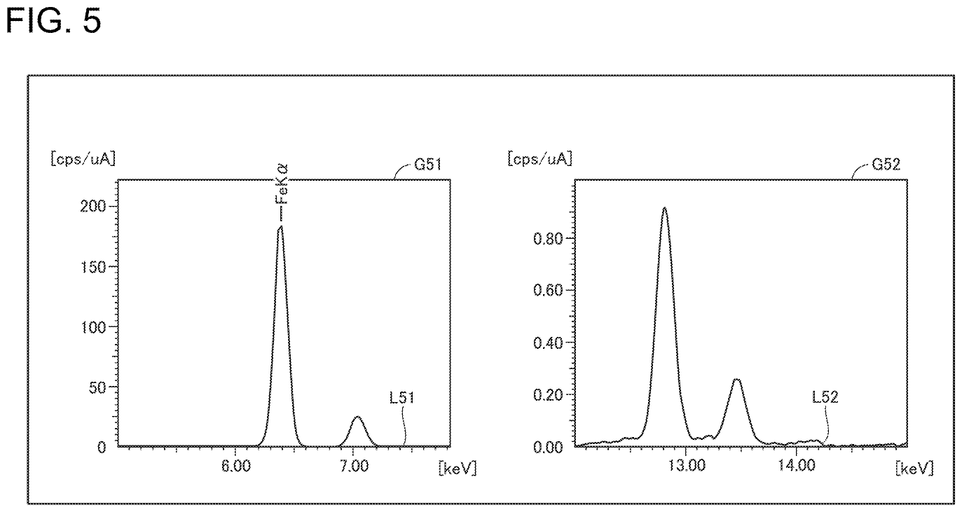

FIG. 5 is a diagram showing one example of an initial spectrum about Fe. FIG. 5 shows a wave height distribution diagram G51 and a wave height distribution diagram G52. The wave height distribution diagram G51 corresponds to an energy region including the main peak. The line L51 shown in the wave height distribution diagram G51 represents the spectrum of the sample. The spectrum includes two peaks. One of the two peaks corresponds to the main peak of Kα of Fe. The wave height distribution diagram G52 corresponds to the energy region including sum peaks. The line L52 shown in the wave height distribution diagram G52 represents the spectrum of the sample. The spectrum includes two sum peaks.

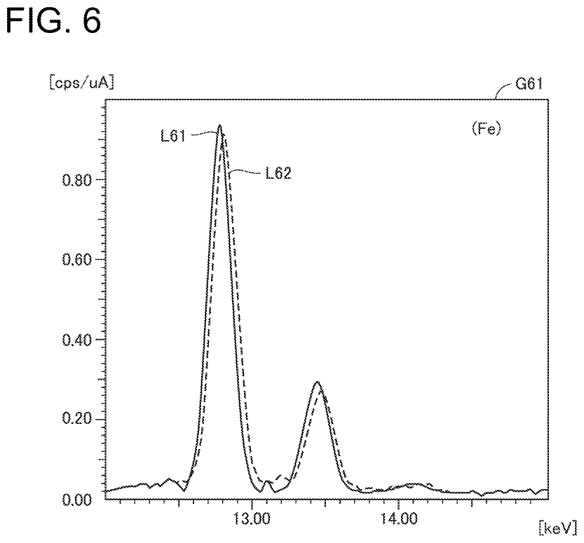

FIG. 6 is a diagram showing an example of the difference between the detection result and the simulation result. In the wave height distribution diagram G61 shown in FIG. 6, the line L61 represents the spectrum acquired as the simulation result, and the line L62 represents the spectrum acquired as a detection result in the X-ray analyzer 1. In FIG. 6, the two peaks of the line L62 are both located higher than the two peaks of the line 61. That is, the spectrum acquired as the detection result in the X-ray analyzer 1 includes a deviation with respect to the actual energy. For example, as the cause of the deviation, the roughness of the width (energy width) of the step at which data is acquired in the X-ray analyzer 1 can be assumed.

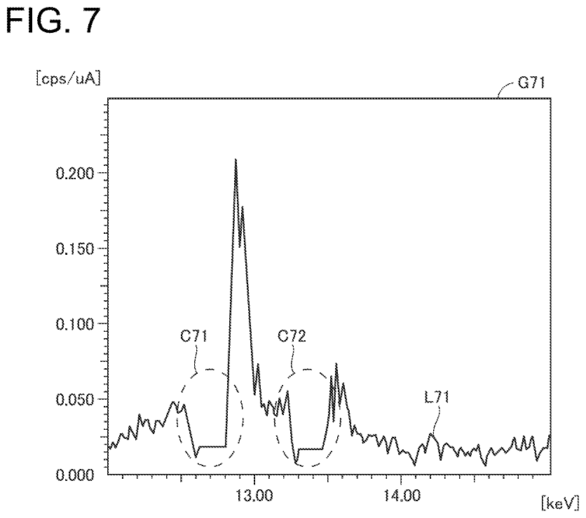

FIG. 7 is a diagram showing one example of the spectrum after removing sum peaks. The line L71 of the wave height distribution diagram G71 shown in FIG. 7 is one example of the spectrum in which sum peaks have been removed by the X-ray analyzer 1.

The line L71 includes areas as shown in C71 and C72 that are largely recessed with respect to the neighboring energy region. As one example of the factors causing such areas, it is assumed that the energy in the detection result includes a deviation with respect to the actual energy as described with reference to FIG. 6. That is, the energy corresponding to the count value subtracted as sum peals include a deviation with respect to the actual energy, and therefore, it is assumed that one example of the factor is that the count value is subtracted from the energy of the area deviated from the energy from which the count value is to be subtracted as a sum peak.

Therefore, the X-ray analyzer 1 may apply an offset value to the energy of the measurement value to be used in calculating the predictive value according to Equation (3). The X-ray analyzer 1 may set an offset value used in this way as a calibrator.

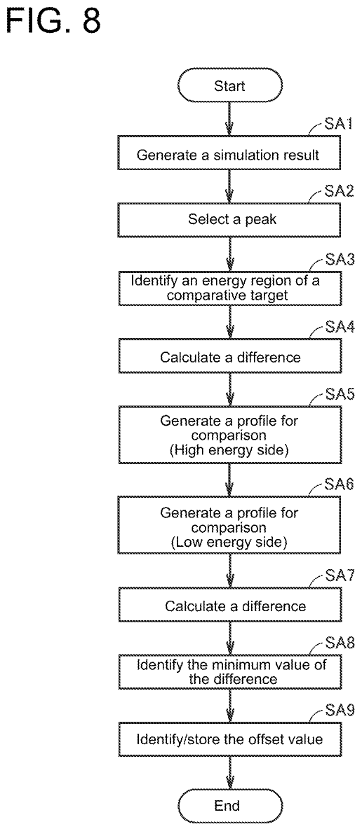

FIG. 8 is a flowchart of the processing executed by the X-ray analyzer 1 for setting an offset value. In one implementation, the processing of FIG. 8 is implemented by the CPU 30 executing a given program.

With reference to FIG. 8, in Step SA1, the X-ray analyzer 1 generates a simulation result. In one implementation, the X-ray analyzer 1 uses dedicated software as a simulation result to generate an X-ray fluorescence spectrum to be assumed for a reference sample.

In Step SA2, the X-ray analyzer 1 selects a given number of peaks in the simulation result. The information identifying the given number may be stored in the data storage area 31B in advance. The peak to be selected may be one peak having a largest count value in a simulation result.

In Step SA3, the X-ray analyzer 1 identifies the energy region to be compared for each of the selected peaks. The energy region to be compared may be half width of a peak.

In Step SA4, the X-ray analyzer 1 calculates the difference of the count value between the simulation result and the detection result, for the energy region identified in Step SA3. The detection result is, for example, an initial spectrum of the above-described reference sample acquired in the X-ray analyzer 1.

In Step SA5, the X-ray analyzer 1 generates NA pieces of comparative profiles in which the detection result used in Step SA4 is shifted to the higher energy side by a given value. The given value is, for example, 1 eV.

In Step SA6, the X-ray analyzer 1 generates NA pieces of comparative profiles in which the detection result used in Step SA4 is shifted to the lower energy side by a given value. The given value is, for example, 1 eV.

In Step SA7, the X-ray analyzer 1 calculates the difference of the count value with respect to the simulation result, for the energy region identified in Step SA3, for each of the NA pieces of comparison profiles generated in Step SA5 and the NA pieces of comparison profiles generated in Step SA6. When “20” is adopted as the NA, 40 pieces of differences are generated in Step SA7.

In Step SA8, the X-ray analyzer 1 identifies the minimum value among the difference calculated in Step SA4 and the difference calculated in Step S7.

In Step SA9, the X-ray analyzer 1 identifies the value of the shift (the value of the shifted energy) corresponding to the minimum value identified in Step SA8 as an offset value and stores it in the identified offset value data storage area 31B. In one implementation, the offset value is stored as “PosOffset” and “PosOffsetEx” described below with reference to FIG. 10.

Thereafter, the X-ray analyzer 1 terminates the processing of FIG. 8.

The X-ray analyzer 1 may use the initial spectrum in which the energy is shifted by the offset value, when calculating the predictive value of the count value for sum peaks according to Equation (3).

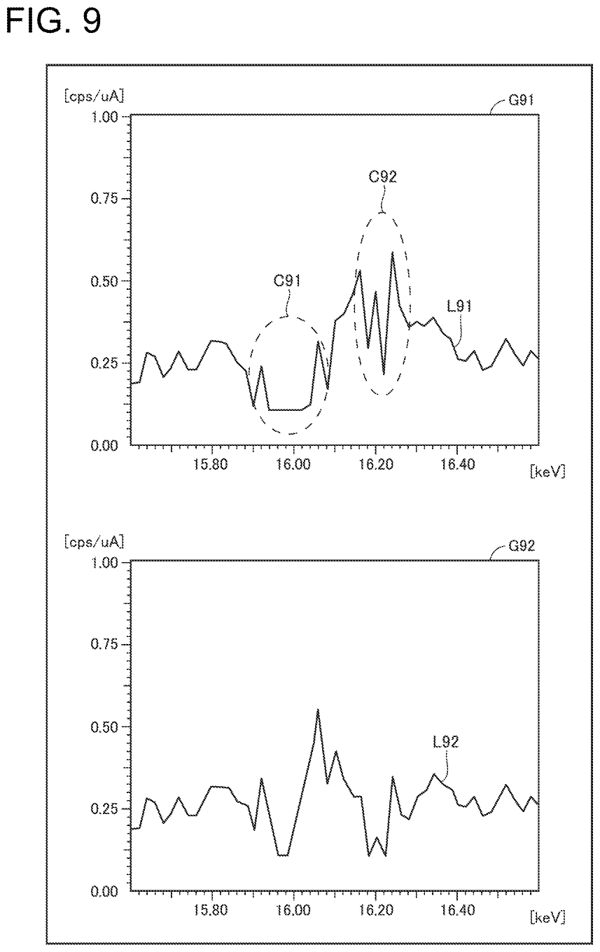

FIG. 9 is a diagram showing an example of a change in the spectrum after removing sum peaks by using an offset value.

FIG. 9 shows a wave height distribution diagram G91 and a wave height distribution diagram G92. The line L91 in the wave height distribution diagram G91 represents a spectrum acquired by removing sum peaks from the initial spectrum using Equation (3) without using an offset value. The line L92 in the wave height distribution diagram G92 represents a spectrum acquired by removing sum peaks from the initial spectrum using Equation (3) using an offset value. The use of an offset value means, as described above, that the initial spectrum is shifted by an offset value and then used to calculate the count value for sum peaks in Equation (3).

In the line L91, at the location indicated by the circle C91, the count value is excessively subtracted, and at the location indicated by the circle C92, the count value is insufficiently subtracted. On the other hand, in the line L92, the count value is appropriately subtracted at the energy regions corresponding to both the circle C91 and the circle C92. That is, by using an offset value, the sum peak removal can be realized more appropriately.

### <Setting Data>

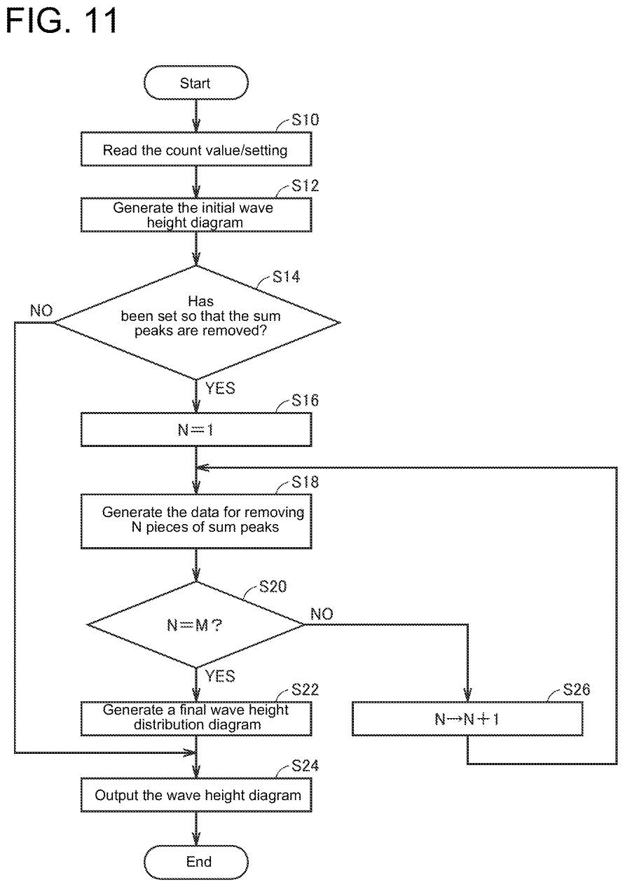

FIG. 10 is a diagram showing one example of setting data to be used in data processing described later with reference to FIG. 11.

In FIG. 10, “Enable” defines whether or not to perform the sum peak removal. When the value is “1,” in the initial spectrum, the sum peak removal is performed. When the value is “0,” in the initial spectrum, the sum peak removal is not performed.

The “CoefMode” defines the calculation method of the CoefMode. When the number is “2,” the CoefMode is calculated according to the above-described Equation (4).

The setting data of FIG. 10 includes the “Coef,” the “CoefA,” and the “CoefE” used in Equation (4) and a setting value of the “FMHMCoef” used as a half width in the predictive value of the sum peak.

The “TopNum” defines the number of main peaks used as the source of the sum peaks.

The “CheckNum” defines the number of target peaks in which sum peaks are generated. The number of target peaks means the number of peaks included in the predictive value of sum peaks described above.

The “MinTopLevel” defines, as a main peak, the threshold of the largest count value of peaks used to generate sum peaks. That is, the peaks having a value greater than the “MinTopLevel” are not utilized for the sum peak generation. In this way, it is possible to prevent the sum peaks generated by the detection error in the initial spectrum from being used.

The “MinCheckLevel” defines the threshold (the ratio of the count value of sum peaks to the sum of all count values) of the target peak.

Each of the “EnergyL” and the “EnergyH” defines, as a main peak, the range (lower limit and upper limit) of the energy of the peak used to generate sum peaks.

The “RecalcBG” defines whether to recalculate a background in generating the initial spectrum.

The “BGRept” defines the number of times the background is recalculated in generating the initial spectrum.

The “BGPoint” defines the number of points of the energy used when recalculating the background in generating the initial spectrum.

The “BGMode” defines the aspect of the automated calculation of the background in generating the initial spectrum. When the value is “1,” an aspect is employed in which the value of the background does not fall below a given value. When the value is “0,” a normal aspect, i.e., an aspect that uses the detected value as it is, is employed.

The “Interpolate” defines whether the sum peak appearance position offset is enabled, that is, whether the initial spectrum is shifted using the above-described offset value in calculating the predictive value of the sum peak.

Each of the “PosOffset” and the “PosOffsetEx” defines a fractional part and an integral part of the above-described offset value.

### <Processing Flow>

FIG. 11 is a flowchart of the processing executed by the X-ray analyzer 1 for outputting the wave height distribution diagram using the sample detected data. In one implementation, the processing of FIG. 11 is performed by the CPU 30 executing a given program.

In Step S10, the X-ray analyzer 1 reads out a count value from the histogram memory 54 and reads out various settings from the data storage area 31B. The settings include the setting data described with reference to FIG. 10.

In Step S12, the X-ray analyzer 1 generates an initial wave height distribution diagram.

In Step S14, the X-ray analyzer 1 determines whether or not the X-ray analyzer 1 is set to remove the sum peaks from the initial wave height distribution diagram. In one implementation, it is determined whether or not the value of “Enable” in the setting data of FIG. 10 is “1.” When the X-ray analyzer 1 determines that the X-ray analyzer 1 is set to remove sum peaks (YES in Step S14), the process proceeds to the control in Step S16. Otherwise (NO in Step S14), the process proceeds to the control in Step S24.

In Step S16, the X-ray analyzer 1 sets the value of the variable N to 1. The variable N represents the number of main peaks used to calculate the predictive value of the sum peaks.

In Step S18, the X-ray analyzer 1 generates sum peak removing data for the N^{th} main peak. An example of the sum peak removing data for the N^{th} main peak is data in the frame M11 and the frame M12 generated for the main peak P11 shown in FIG. 4. Another example of sum peak removing data is data in the frames M21 to M23 generated for the main peak P21 shown in FIG. 4. The sum peak removing data generated for each main peak constitutes one example of the “predictive value” in removing sum peaks.

In generating the sum peak removing data, there is a case in which the X-ray analyzer 1 shifts the initial spectrum by an offset value. More specifically, in a case where the value of the “Interpolate” in the setting data shown in FIG. 10 is for enabling the offset, the X-ray analyzer 1 shifts the initial spectrum by the offset value and then generates a thumb peak removing data. In a case where the value of the “Interpolate” in the setting data shown in FIG. 10 is for enabling the offset, the X-ray analyzer 1 generates a sum peak removing data without shifting the initial spectrum.

In Step S20, the X-ray analyzer 1 determines whether or not the value of the variable N has reached a predetermined value M. The value M is the number of main peaks used to generate the sum peak removing data and has been stored in the data storage area 31B as the “TopNum” shown in FIG. 10. When the X-ray analyzer 1 determines that the value of the variable N has reached M (YES in Step S20), the process advances to the control in Step S22. Otherwise (NO in Step S20), the process advances to the control in Step S26.

In Step S26, the X-ray analyzer 1 adds 1 to the value of the variable N to update it and returns the process to the control in Step S18.

In Step S22, the X-ray analyzer 1 generates a final wave height distribution diagram. More specifically, the X-ray analyzer 1 generates a final spectrum by deleting all of the count values included in each of the M pieces of peak removing data generated in Step S18 from the initial spectrum included in the initial wave height distribution diagram. Then, the X-ray analyzer 1 combines the final spectrum with the vertical axis and the horizontal axis to generate a final wave height distribution diagram.

For example, it is assumed that the X-ray analyzer 1 generated, as peak removing data, peak removing data (data indicated in the frames M11 and M12) from the main peak P11 shown in FIG. 4 and the peak removing data (data indicated in the frames M21, M22, and M23) from the main peak P21 shown in FIG. 4. In this case, the X-ray analyzer 1 generates a final spectrum by subtracting the count value of each energy of the peak removing data from the main peak P11 and the count value of each energy of the peak removing data from the main peak P11 from the count value of each energy of the initial spectrum.

In Step S24, the X-ray analyzer 1 outputs a wave height distribution diagram. Thereafter, the X-ray analyzer 1 terminates the processing shown in FIG. 11. In a case where the X-ray analyzer 1 is set to remove sum peaks (YES in Step S14), the wave height distribution diagram outputted in Step S24 is a final wave height distribution diagram generated in Step S22. In a case where the X-ray analyzer 1 is set not to remove sum peaks (NO in Step S14), the wave height distribution diagram outputted in Step S24 is an initial wave height distribution diagram.

In the embodiment described above, as the prediction value of the count value constituting the sum peak, the sum peak removing data (data indicated in the frames M11 and M12) from the main peak P11 shown in FIG. 4 and the sum peak removing data (data indicated in the frames M21, M22, and M23) from the main peak P21 shown in FIG. 4 are exemplified. The predictive value is calculated based on Equation (3). The CoefMode of Equation (3) is represented by Equation (4). Equation (4) includes, as “e,” the energy of the characteristic X-rays of the element to be calculated for the predictive value. That is, in this embodiment, the energy of the characteristic X-rays of the element due to sum peaks is reflected in a predictive value. With this, the predictive value reflects the energy dependence of the X-rays at the ratio at which sum peaks occurs.

### [Aspects]

It will be understood by those skilled in the art that the plurality of exemplary embodiments described above is illustrative of the following aspects.

### (Item 1)

An X-ray fluorescence analyzer according to one aspect of the present invention comprising:

an X-ray detector configured to detect X-rays of a sample;

a data processing unit configured to generate an initial spectrum of the sample by processing an output of the X-ray detector; and

a processor configured to perform removal processing for removing one or more sum peaks from the initial spectrum,

wherein the removal processing includes:

calculating a predictive value of a count value forming a sum peak, for each of one or more elements constituting the sample, using a count value and a value of energy of characteristic X-rays in the initial spectrum; and

subtracting the predictive value calculated for each of the one or more elements constituting the sample from the count value of the initial spectrum.

According to the X-ray fluorescence analyzer as recited in the above-described Item 1, sum peaks can be appropriately removed.

### (Item 2)

In the X-ray fluorescence analyzer as recited in the above-described Item 1, the predictive value decreases as the value of the energy of the characteristic X-rays to be used increases.

According to the X-ray fluorescence analyzer described in the above-described Item 2, the energy dependence of the characteristic X-rays of the original element can be reflected in the appearance ratio of sum peaks.

### (Item 3)

In the X-ray fluorescence analyzer as recited in the above-described Item 2, it may be configured such that

calculating the predictive value includes calculating a product of the count value in the initial spectrum, a first coefficient, and a second coefficient, and

the second coefficient includes a term acquired by subtracting the value of the energy of the characteristic X-rays from a given constant.

According to the X-ray fluorescence analyzer as recited in the above-described Item 3, the energy dependence of the characteristic X-rays of the original element can be directly reflected in the appearance ratio of sum peaks.

### (Item 4)

In the X-ray fluorescence analyzer as recited in the above-described Item 3, it may be configured such that the given constant is a value of energy of characteristic X-rays of a given element.

According to the X-ray fluorescence analyzer as recited in the above-described Item 4, the calculation of the predictive value for a given element can be easily performed.

### (Item 5)

In the X-ray fluorescence analyzer as recited in any one of the above-described Items 1 to 4, it may be configured such that

the processor is configured to

identify an offset value for energy using the initial spectrum and simulation data corresponding to the initial spectrum, and

use the initial spectrum shifted by the offset value to calculate the predictive value.

According to the X-ray fluorescence analyzer as recited in the above-described Item 5, even in a case where the energy shift has occurred in the initial spectrum, the effect of the shift can be reduced in the calculation of predictive value.

### (Item 6)

In the X-ray fluorescence analyzer as recited in the above-described Item 5, it may be configured such that the offset value is calculated based on a difference between the initial spectrum and the simulation data corresponding to the initial spectrum.

According to the X-ray fluorescence analyzer as recited in the above-described Item 6, the offset value can be calculated easily and appropriately.

### (Item 7)

The data processing method according to one aspect of the present invention relates to a data processing method of processing an initial spectrum of a sample acquired by processing an output of an X-ray detector, the method may comprise the steps of:

calculating a predictive value of a count value forming a sum peak, for each of one or more elements constituting the sample, using a count value and a value of energy of characteristic X-rays in the initial spectrum; and

subtracting the predictive value calculated for each of one or more elements constituting the sample from the count value of the initial spectrum.

According to the data processing method as recited in the above-described Item 7, sum peaks can be appropriately removed in the analysis result of the X-ray fluorescence analyzer.

### (Item 8)

In the data processing method as recited in the above-described Item 7, it may be configured such that

the predictive value decreases as the value of the energy of the characteristic X-rays to be used increases.

According to the data processing method as recited in the above-described Item 8, the energy dependence of the characteristic X-rays of the original element can be reflected in the appearance ratio of sum peaks.

### (Item 9)

In the data processing method as recited in the above-described Item 8, it may be configured such that

calculating the predictive value includes calculating a product of the count value in the initial spectrum, a first coefficient, and a second coefficient, and

the second coefficient includes a term acquired by subtracting the value of the energy of the characteristic X-rays from a given constant.

According to the data processing method as recited in the above-described Item 9, the energy dependence of the characteristic X-rays of the original element can be directly reflected in the appearance ratio of sum peaks.

### (Item 10)

In the data processing method as recited in the above-described Item 9, it may be configured such that

the given constant is a value of energy of characteristic X-rays of a given element.

According to the data processing method as recited in the above-described Item 10, the calculation of predictive value for a given element can be facilitated.

### (Item 11)

The data processing method as recited in any one of the above-described Items 7 to 10 may be configured to further comprise a step of:

identifying an offset value for energy using the initial spectrum and simulation data corresponding to the initial spectrum,

wherein the initial spectrum shifted by the offset value is used to calculate the predictive value.

According to the data processing method as recited in the above-described Item 11, even in a case where an energy shift has occurred in the initial spectrum, the effect of the shift can be reduced in calculating the predictive value.

### (Item 12)

In the data processing method as recited in the above-described Item 11, it may be configured such that

identifying the offset value includes:

calculating a difference between the initial spectrum and the simulation data corresponding to the initial spectrum.

According to the data processing method as recited in the above-described Item 12, the offset value can be calculated easily and appropriately.

### (Item 13)

A recording medium is configured to store a program non-temporarily. The program is executed by a computer to make the computer perform the data processing method recited in any one of the above-described Items 7 to 12.

According to the program as recited in the above-described Item 13, sum peaks can be appropriately removed in the analysis result of the X-ray fluorescence analyzer.

Although some embodiments of the present invention have been described, the embodiments disclosed herein are to be considered in all respects as illustrative and not restrictive. The scope of the present invention is indicated by claims, and it is intended to include all modifications within the meanings and ranges equivalent to those of the claims.

1. An X-ray fluorescence analyzer comprising:
an X-ray detector configured to detect X-rays of a sample;
a data processing unit configured to generate an initial spectrum of the sample by processing an output of the X-ray detector; and
a processor configured to perform removal processing for removing one or more sum peaks from the initial spectrum,
wherein the removal processing includes:
calculating a predictive value of a count value forming a sum peak, for each of one or more elements constituting the sample, using a count value and a value of energy of characteristic X-rays in the initial spectrum; and
subtracting the predictive value calculated for each of the one or more elements constituting the sample from the count value of the initial spectrum.

2. The X-ray fluorescence analyzer as recited in claim 1,
wherein the predictive value decreases as the value of the energy of the characteristic X-rays to be used increases.

3. The X-ray fluorescence analyzer as recited in claim 2,
wherein calculating the predictive value includes calculating a product of the count value in the initial spectrum, a first coefficient, and a second coefficient, and
wherein the second coefficient includes a term acquired by subtracting the value of the energy of the characteristic X-rays from a given constant.

4. The X-ray fluorescence analyzer as recited in claim 3,
wherein the given constant is a value of energy of characteristic X-rays of a given element.

5. The X-ray fluorescence analyzer as recited in claim 1,
wherein the processor is configured to
identify an offset value for energy using the initial spectrum and simulation data corresponding to the initial spectrum, and
use the initial spectrum shifted by the offset value to calculate the predictive value.

6. The X-ray fluorescence analyzer as recited in claim 5,
wherein the offset value is calculated based on a difference between the initial spectrum and the simulation data corresponding to the initial spectrum.

7. A data processing method of processing an initial spectrum of a sample acquired by processing an output of an X-ray detector, the method comprising the steps of:
calculating a predictive value of a count value forming a sum peak, for each of one or more elements constituting the sample, using a count value and a value of energy of characteristic X-rays in the initial spectrum; and
subtracting the predictive value calculated for each of one or more elements constituting the sample from the count value of the initial spectrum.

8. The data processing method as recited in claim 7,
wherein the predictive value decreases as the value of the energy of the characteristic X-rays to be used increases.

9. The data processing method as recited in claim 8,
wherein calculating the predictive value includes calculating a product of the count value in the initial spectrum, a first coefficient, and a second coefficient, and
wherein the second coefficient includes a term acquired by subtracting the value of the energy of the characteristic X-rays from a given constant.

10. The data processing method as recited in claim 9,
wherein the given constant is a value of energy of characteristic X-rays of a given element.

11. The data processing method as recited in claim 7, further comprising a step of:
identifying an offset value for energy using the initial spectrum and simulation data corresponding to the initial spectrum,
wherein the initial spectrum shifted by the offset value is used to calculate the predictive value.

12. The data processing method as recited in claim 11,
wherein identifying the offset value includes:
calculating a difference between the initial spectrum and the simulation data corresponding to the initial spectrum.

13. A recording medium configured to store a program non-temporarily,
wherein the program is executed by a computer to make the computer perform the data processing method recited in claim 7.
